(19) United States
(12) Patent Application Publication
(10) Pub. No.: US 2018/0062165 A1
(43) Pub. Date: Mar. 1, 2018

(54) ELECTRODE MATERIAL, METHOD FOR MANUFACTURING ELECTRODE MATERIAL, ELECTRODE, AND LITHIUM ION BATTERY

(71) Applicant: SUMITOMO OSAKA CEMENT CO., LTD., Tokyo (JP)

(72) Inventors: Kouji OONO, Chiba-Shi (JP); Takao KITAGAWA, Funabashi-shi (JP)

(21) Appl. No.: 15/463,139

(22) Filed: Mar. 20, 2017

(30) Foreign Application Priority Data
Aug. 31, 2016 (JP) 2016-169915

(51) Int. Cl. H01M 4/36; H01M 4/58; H01M 10/0525; H01M 4/62; H01M 4/04

(52) U.S. Cl. CPC H01M 4/366; H01M 4/5825; H01M 2004/021; H01M 4/625; H01M 4/0471; H01M 10/0525

(57) ABSTRACT

An electrode material made of a carbonaceous-coated electrode active material having primary particles of an electrode active material and aggregates of the primary particles and a carbonaceous film that coats the primary particles of the electrode active material and the aggregates of the primary particles, in which an average particle diameter of the carbonaceous-coated electrode active material is 30 nm or more and 200 nm or less, a crystallite diameter obtained from a full width at half maximum of a (020) plane in an X-ray diffraction measurement is 30 nm or more and 100 nm or less, a specific surface area obtained using a BET method is 10 m²/g or more and 25 m²/g or less, and a carbon content is 0.5% by mass or more and 2.5% by mass or less.

### CROSS-REFERENCE TO RELATED APPLICATIONS

This application claims the benefit of Japanese Patent Application No. 2016-169915 filed Aug. 31, 2016, the disclosure of which is herein incorporated by reference in its entirety.

### BACKGROUND OF THE INVENTION

### Field of the Invention

The present invention relates to an electrode material, a method for manufacturing the electrode material, an electrode, and a lithium ion battery.

Description of Related Art

In recent years, as small-size, lightweight, and high-capacity batteries, non-aqueous electrolyte-based secondary batteries such as lithium ion batteries have been proposed and put into practical use. Lithium ion batteries are constituted of a cathode and an anode which have properties capable of reversibly intercalating and deintercalating lithium ions and a non-aqueous electrolyte.

Lithium ion batteries weigh less and have a smaller size and a higher energy than secondary batteries of the related art such as lead batteries, nickel-cadmium batteries, and nickel-hydrogen batteries, are used as power supplies for mobile electronic devices such as mobile phones and notebook-type personal computers, and, in recent years, also have been studied as high-output power supplies for electric vehicles, hybrid vehicles, and electric tools. Electrode active materials for batteries that are used as the above-described high-output power supplies are required to have high-speed charge and discharge characteristics. In addition, studies are also made to apply the electrode active materials for the smoothing of power generation loads or to large-scale batteries such as stationary power supplies and backup power supplies, and the absence of problems regarding resource amounts as well as long-term safety and reliability is also considered to be important.

Cathodes in lithium ion batteries are constituted of an electrode material including a lithium-containing metal oxide having properties capable of reversibly intercalating and deintercalating lithium ions which is called a cathode active material, a conductive auxiliary agent, and a binder, and this electrode material is applied onto the surface of a metal foil which is called a current collector, thereby producing cathodes. As the cathode active material for lithium ion batteries, generally, lithium cobalt oxide (LiCoO₂) is used, and, additionally, lithium (Li) compounds such as lithium nickel oxide (LiNiO₂), lithium manganese oxide (LiMn₂O₄), and lithium iron phosphate (LiFePO₄) are used. Among these, lithium cobalt oxide or lithium nickel oxide has a problem of the toxicity or resource amounts of elements and a problem such as instability in charged states. In addition, lithium manganese oxide is pointed out to have a problem of being dissolved in electrolytes at high temperatures. On the other hand, lithium iron phosphate has excellent long-term safety and reliability, and thus phosphate-based electrode materials having an olivine structure, which are represented by lithium iron phosphate, have been attracting attention in recent years (for example, refer to Japanese Laid-open Patent Publication No. 2013-161654).

### SUMMARY OF THE INVENTION

Since the phosphate-based electrode materials have insufficient electron conductivity, in order to charge and discharge large currents, a variety of means such as the miniaturization of particles and the conjugation with conductive substances are required, and a number of efforts are underway.

However, conjugation using a large amount of a conductive substance causes a decrease in electrode densities, and thus a decrease in the density of batteries, that is, a decrease in capacities per unit volume is caused. As a method for solving this problem, a carbon coating method using an organic substance solution as a carbon precursor which is an electron conductive substance has been found. In this method in which the organic substance solution and electrode active material particles are mixed together, and then the mixture is dried and thermally treated in a non-oxidative atmosphere, thereby carbonizing an organic substance, it is possible to extremely efficiently coat the surfaces of the electrode active material particles with a minimum necessary amount of the electron conductive substance, and conductivity can be improved without significantly decreasing electrode densities.

However, the carbonization temperature of the organic substance which is a carbon source is generally a high temperature, and thus, during the manufacturing of these electrode materials, there has been a problem in that active material particles come into contact with each other, the sintering and particle growth of some of the active material particles are caused during high-temperature carbonization, and thus fine particles cannot be obtained. Particularly, the carbonization temperature is preferably high in order to obtain carbon coatings of a higher crystallinity (higher conductivity), but it is important to prevent the active material particles from being exposed to high temperatures in order to suppress the sintering and particle growth of the active material particles, and thus these two facts have a trade-off relationship with each other.

The present invention has been made in consideration of the above-described circumstances, and an object of the present invention is to provide an electrode material capable of decreasing direct current resistances and increasing discharge capacities, a method for manufacturing the electrode material, an electrode using the electrode material, and a lithium ion battery.

The present inventors carried out intensive studies in order to achieve the above-described object and consequently found that, when an organic substance (A) which serves as a carbon source, a highly water-absorbing polymer (B), and an electrode active material and/or an electrode active material precursor (C) are mixed together, and the obtained mixture is humidified, the highly water-absorbing polymer (B) is swollen, and the particle gaps in the electrode active material and/or the electrode active material precursor (C) are extended, and thus, afterwards, even when the organic substance (A) is carbonized at a high temperature, the high temperature does not easily cause the particle growth and sintering of the electrode active material, and thus electrode materials made of fine active material particles coated with a carbonaceous substance having a higher crystallinity can be obtained.

The present invention has been completed on the basis of the above-described findings.

That is, the present invention provides the following [1] to [6].

[1] An electrode material made of a carbonaceous-coated electrode active material having primary particles of an electrode active material and aggregates of the primary particles, and a carbonaceous film that coats the primary particles of the electrode active material and the aggregates of the primary particles, in which an average particle diameter of the carbonaceous-coated electrode active material is 30 nm or more and 200 nm or less, a crystallite diameter obtained from a full width at half maximum of a (020) plane in an X-ray diffraction measurement is 30 nm or more and 100 nm or less, a specific surface area obtained using a BET method is 10 m²/g or more and 25 m²/g or less, and a carbon content is 0.5% by mass or more and 2.5% by mass or less.

[2] The electrode material according to [1], in which the electrode active material is an electrode active material substance represented by General Formula (1).

LiₐAₓBO₄ (1)

(here, in the formula, A represents at least one element selected from the group consisting of Mn, Fe, Co, and Ni, B represents at least one element selected from the group consisting of P, Si, and S, 0≦4, and 0<x<1.5).

[3] A method for manufacturing the electrode material according to [1] or [2], including: a first step of obtaining a mixture including an organic substance (A) which serves as a carbon source, a highly water-absorbing polymer (B), and an electrode active material and/or an electrode active material precursor (C); a second step of obtaining a solid substance by humidifying the mixture obtained in the first step; and a third step of thermally treating the solid substance obtained in the second step in a non-oxidative atmosphere at 600° C. or higher and 1,000° C. or lower.

[4] The method for manufacturing the electrode material according to [3], in which the highly water-absorbing polymer (B) is a polymer absorbing water that weighs ten or more times a weight of the polymer.

[5] An electrode formed using the electrode material according to [1] or [2].

[6] A lithium ion battery including: a cathode made of the electrode according to [5].

According to the present invention, it is possible to provide an electrode material capable of decreasing direct current resistances and increasing discharge capacities, a method for manufacturing the electrode material, an electrode using the electrode material, and a lithium ion battery.

### DETAILED DESCRIPTION OF THE INVENTION

### Electrode material

An electrode material of the present invention is made of a carbonaceous-coated electrode active material having primary particles of an electrode active material and aggregates of the primary particles and a carbonaceous film that coats the primary particles of the electrode active material and the aggregates of the primary particles, the average particle diameter of the carbonaceous-coated electrode active material is 30 nm or more and 200 nm or less, the crystallite diameter obtained from the full width at half maximum of a (020) plane in an X-ray diffraction measurement is 30 nm or more and 100 nm or less, the specific surface area obtained using a BET method is 10 m²/g or more and 25 m²/g or less, and the carbon content is 0.5% by mass or more and 2.5% by mass or less.

The electrode active material that is used in the present invention is constituted of primary particles and aggregates of the primary particles (secondary particles). The shape of the electrode active material is not particularly limited, but is preferably spherical, particularly, truly spherical. When the electrode active material has a spherical shape, it is possible to decrease the amount of a solvent during the preparation of paste for forming electrodes using the electrode material of the present invention, and it also becomes easy to apply the paste for forming electrodes to current collectors. Meanwhile, the paste for forming electrodes can be prepared by, for example, mixing the electrode material of the present invention, a binder resin (binder), and a solvent.

The electrode active material is preferably an electrode active material substance represented by General Formula (1) from the viewpoint of a high discharge capacity and a high energy density.

LiₐAₓBO₄ (1)

(here, in the formula, A represents at least one element selected from the group consisting of Mn, Fe, Co, and Ni, B represents at least one element selected from the group consisting of P, Si, and S, 0≦a<4, and 0<x<1.5).

In the formula, A is at least one element selected from the group consisting of Mn, Fe, Co, and Ni, and, among these, Mn and Fe are preferred, and Fe is more preferred.

B is at least one element selected from the group consisting of P, Si, and S, and, among these, P is preferred from the viewpoint of excellent safety and cycle characteristics.

a is 0 or more and less than 4, preferably 0.5 or more and 3 or less, more preferably 0.5 or more and 2 or less, and particularly preferably 1. x is more than 0 and less than 1.5, preferably 0.5 or more and 1 or less, and, among these, 1 is preferred.

The electrode active material substance represented by General Formula (1) is preferably LiₐAₓPO₄ having an olivine structure and more preferably LiFePO₄.

As the electrode active material substance (LiₐAₓBO₄) represented by General Formula (1), a substance manufactured using a method of the related art such as a solid-phase method, a liquid-phase method, or a gas-phase method can be used.

LiₐAₓBO₄ can be obtained by, for example, hydrothermally synthesizing a slurry-form mixture obtained by mixing a Li source, an A source, a B source, and water, cleaning the obtained precipitate with water so as to generate an electrode active material precursor, and furthermore, calcinating the electrode active material precursor. A pressure-resistant airtight container is preferably used in the hydrothermal synthesis.

Here, examples of the Li source include lithium salts such as lithium acetate (LiCH₃COO) and lithium chloride (LiCl) , lithium hydroxide (LiOH), and the like, and at least one selected from the group consisting of lithium acetate, lithium chloride, and lithium hydroxide is preferably used.

Examples of the A source include chlorides, carboxylates, hydrosulfates, and the like which include at least one element selected from the group consisting of Mn, Fe, Co, and Ni. For example, in a case in which the A source is Fe, examples of the Fe source include divalent iron salts such as iron (II) chloride (FeCl₂), iron (II) acetate (Fe(CH₃COO)₂), and iron (II) sulfate (FeSO₄) , and, among these, at least one selected from the group consisting of iron (II) chloride, iron (II) acetate, and iron (II) sulfate is preferably used.

Examples of the B source include compounds including at least one element selected from the group consisting of P, Si, and S. For example, in a case in which the B source is P, examples of the P source include phosphoric acid compounds such as phosphoric acid(H₃PO₄), ammonium dihydrogen phosphate(NH₄H₂PO₄), diammonium phosphate ((NH4₄)₂HPO₄), and the like, and at least one selected from the group consisting of phosphoric acid, ammonium dihydrogen phosphate, and diammonium phosphate is preferably used.

In the electrode material of the present invention, the crystallite diameter obtained from the full width at half maximum of a (020) plane in an X-ray diffraction measurement is 30 nm or more and 100 nm or less, preferably 50 nm or more and 100 nm or less, more preferably 50 nm or more and 80 nm or less, and still more preferably 50 nm or more and 70 nm or less. When the crystallite diameter is less than 30 nm, a large amount of carbon is required in order to sufficiently coat the electrode active material surface with a carbonaceous film, and there is a concern that necessity of a large amount of the binder may decrease the amount of the active material in electrodes and the capacity of batteries. Similarly, a concern of films being peeled off due to the lack of the binding force is also likely to be caused. When the crystallite diameter exceeds 100 nm, the internal resistance of the electrode active material increases, and, in a case in which batteries are formed, there is a concern that discharge capacities at a high charge-discharge rate may decrease.

Meanwhile, the crystallite diameter can be calculated from the Debye-Scherrer equation using the full width at half maximum of the diffraction peak and the diffraction angle (2θ) of the (020) plane in a powder X-ray diffraction pattern that is measured and obtained using an X-ray diffractormeter (for example, RINT2000, manufactured by Rigaku Corporation).

The carbonaceous film that coats the primary particles of the electrode active material and the aggregates of the primary particles can be obtained by carbonizing an organic substance which serves as the raw material of the carbonaceous film. The organic substance is not particularly limited as long as the organic substance is capable of forming the carbonaceous film on the surface of the electrode active material, and examples thereof include polyvinyl alcohol (PVA), polyvinyl pyrrolidone, cellulose, starch, gelatin, carboxymethyl cellulose, methyl cellulose, hydroxymethyl cellulose, hydroxyethyl cellulose, polyacrylic acid, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyethers, divalent alcohols, trivalent alcohols, and the like. These organic substances may be used singly or a mixture of two or more organic substances may be used.

The average particle diameter of the carbonaceous-coated electrode active material is 30 nm or more and 200 nm or less, preferably 50 nm or more and 200 nm or less, more preferably 50 nm or more and 150 nm or less, and still more preferably 60 nm or more and 100 nm or less. When the average particle diameter is less than 30 nm, a large amount of the biding agent becomes necessary in order to produce electrodes, the amount of the active material in electrodes decreases, and there is a concern that the capacities of batteries may decrease. Similarly, a concern of films being peeled off due to the lack of the binding force is also likely to be caused. When the average particle diameter exceeds 200 nm, it is difficult to obtain sufficient high-speed charge and discharge performance.

Meanwhile, the average particle diameter can be obtained by number-averaging the particle diameters of 200 or more particles measured by scanning electron microscope (SEM) observation.

The specific surface area of the electrode material of the present invention obtained using a BET method is 10 m²/g or more and 25 m²/g or less, preferably 10 m²/g or more and 20 m²/g or less, and more preferably 12 m²/g or more and 18 m²/g or less. When the specific surface area is less than 10 m²/g, intercalation and deintercalation reactions of lithium ions on the electrode active material surface are limited, and there is a concern that discharge capacities that are sufficient in practical use may not obtained. When the specific surface area exceeds 25 m²/g, a large amount of the binder becomes necessary in order to produce electrodes, the amount of the active material in electrodes decreases, and there is a concern that the capacities of batteries may decrease. Similarly, a concern of films being peeled off due to the lack of the binding force is also likely to be caused.

Meanwhile, the specific surface area can be measured using a BET method and a specific surface area meter (for example, manufactured by MicrotracBEL Corp., trade name: BELSORP-mini).

In addition, the content of carbon included in the electrode material of the present invention is 0.5% by mass or more and 2.5% by mass or less, preferably 0.8% by mass or more and 1.3% by mass or less, and more preferably 0.8% by mass or more and 1.2% by mass or less. When the content of carbon is less than 0.5% by mass, there is a concern that it may be impossible to sufficiently increase electron conductivity, and, when the content of carbon exceeds 2.5% by mass, electrode densities decrease, which is useless.

Meanwhile, the content of carbon can be measured using a carbon analyzer (for example, manufactured by Horiba Ltd., carbon/sulfur combustion analyzer EMIA-810W).

The resistivity of a green compact of the electrode material of the present invention which has been molded at a pressure of 50 MPa is preferably 1 MΩ·cm or less, more preferably 3 kΩ·cm or less, still more preferably 1,000 Ω·cm or less, and far still more preferably 150 Ω·cm or less . When the resistivity is 1 MΩ·cm or less, in a case in which batteries are formed, it is possible to increase discharge capacities at a high charge-discharge rate.

Meanwhile, the resistivity of the green compact can be measured using a method described in the examples.

Method for manufacturing electrode material

A method for manufacturing the electrode material of the present invention includes a first step of obtaining a mixture including an organic substance (A) which serves as a carbon source, a highly water-absorbing polymer (B), and an electrode active material and/or an electrode active material precursor (C), a second step of obtaining a solid substance by humidifying the mixture obtained in the first step, and a third step of thermally treating the solid substance obtained in the second step in a non-oxidative atmosphere at 600° C. or higher and 1,000° C. or lower.

First step

The present step is a step of obtaining a mixture including an organic substance (A) which serves as a carbon source, a highly water-absorbing polymer (B), and an electrode active material and/or an electrode active material precursor (C).

As the organic substance (A) and the electrode active material and/or the electrode active material precursor (C), it is possible to use those described in the section of “electrode material” respectively.

In addition, the highly water-absorbing polymer (B) in the present specification refers to a polymer material which absorbs water that weighs at least several times to several tens of times the weight of the polymer material and swells when left to stand at 35° C. and a relative humidity of 100% for 48 hours.

In the present invention, from the viewpoint of suppressing the particle growth and calcination of the electrode active material, the highly water-absorbing polymer (B) is preferably a polymer absorbing water that weighs ten or more times the weight of the polymer and more preferably a polymer absorbing water that weighs 100 or more times the weight of the polymer.

The highly water-absorbing polymer (B) is not particularly limited, and examples thereof include polyacrylate-based polymers, polyalginate-based polymers, polyvinyl alcohol-acrylate-based polymers, acrylate-acrylamide-based polymers, polyacetal carboxylate-based polymers, isobutylene-maleic anhydride copolymers, polyvinyl alcohol-based polymers, carboxylmethyl cellulose-based polymers, polyacrylonitrile-based crosslinked bodies, and the like. These highly water-absorbing polymers (B) may be used singly, or two or more highly water-absorbing polymers may be jointly used.

The blending ratio between the organic substance (A) and the electrode active material and/or the electrode active material precursor (C) is preferably 0.5 parts by mass or more and 2.5 parts by mass or less in terms of the amount of carbon obtained from the organic substance (A) with respect to 100 parts by mass of an active material that is obtained from the electrode active material and/or the electrode active material precursor (C). The actual blending amount varies depending on the carbonization amount (the kind or carbonization conditions of the carbon source) by means of heating carbonization and is approximately 0.7 parts by weight to 6 parts by weight.

The blending ratio [(B)/(C)] of the highly water-absorbing polymer (B) to the electrode active material and/or the electrode active material precursor (C) is preferably 0.1/100 or more and 10/100 or less and more preferably 0.2/100 or more and 5/100 or less. When the blending ratio is set in the above-described range, it is possible to set the crystallite diameter of the electrode active material in the above-described range.

The organic substance (A) , the highly water-absorbing polymer (B), and the electrode active material and/or the electrode active material precursor (C) are dissolved or dispersed in water, thereby preparing a mixture. A method for dissolving or dispersing the organic substance (A), the highly water-absorbing polymer (B), and the electrode active material and/or the electrode active material precursor (C) in water is not particularly limited, and it is possible to use, for example, a dispersion device such as a planetary ball mill, an oscillation ball mill, a bead mill, a paint shaker, or an attritor.

In addition, when the organic substance (A), the highly water-absorbing polymer (B), and the electrode active material and/or the electrode active material precursor (C) are dissolved or dispersed in water, it is preferable to disperse the electrode active material and/or the electrode active material precursor (C) in water, then, add the organic substance (A) and the highly water-absorbing polymer (B) thereto, and stir the components.

Second step

The present step is a step of obtaining a solid substance by humidifying the mixture obtained in the first step.

When the mixture obtained in the first step is humidified, the highly water-absorbing polymer (B) in the mixture swells, and thus particle gaps in the electrode active material and/or the electrode active material precursor (C) extend, and substance migration between the particles of the electrode active material and/or the electrode active material precursor (C) is suppressed. Therefore, during a thermal treatment described below, the growth and sintering of the particles does not easily occur even when the solid substance is heated at a high temperature, and it is possible to set the crystallite diameter of the electrode active material in the above-described range.

The humidification is preferably carried out at a temperature of 25° C. or higher and 40° C. or lower and a relative humidity of 75% or more and 100% or less for 30 minutes or longer and 48 hours or shorter and more preferably carried out at a temperature of 25° C. or higher and 35° C. or shorter and a relative humidity of 85% or higher and 100% or lower for 1 hour or longer and 12 hours or shorter.

Third step

The present step is a step of thermally treating the solid substance obtained in the second step in a non-oxidative atmosphere at 600° C. or higher and 1,000° C. or lower.

The non-oxidative atmosphere is preferably an inert atmosphere of nitrogen (N₂), argon (Ar), or the like, and, in a case in which it is necessary to further suppress oxidation, a reducing atmosphere including approximately several percentages by volume of a reducing gas such as hydrogen (H₂) is preferred. In addition, for the purpose of removing organic components evaporated in the non-oxidative atmosphere during the thermal treatment, a susceptible or burnable gas such as oxygen (O₂) may be introduced into the inert atmosphere.

The thermal treatment is carried out at a temperature in a range of 600° C. or higher and 1,000° C. or lower and preferably 700° C. or higher and 900° C. or lower for 1 to 24 hours, preferably, 1 to 6 hours.

When the thermal treatment temperature is lower than 600° C., the carbonization of the organic substance becomes insufficient, and there is a concern that it may be impossible to increase electron conductivity, and, when the thermal treatment temperature is higher than 1,000° C., there is a concern that the active material may be decomposed or it may be impossible to suppress the growth of particles.

In addition, the temperature-increase rate is preferably 10° C./minute or more and more preferably 20° C./minute or more. When the temperature-increase rate is set to 10° C./minute or more, the highly water-absorbing polymer, which has swollen in the second step, being dried and shrunk is suppressed, and it is possible to suppress the occurrence of the particle growth and sintering of the electrode active material.

According to the manufacturing method of the present invention, it is possible to suppress the particle growth and sintering of the electrode active material even when the solid substance is heated at a high temperature, and thus it is possible to carbonize even a smaller amount of the organic substance at a high temperature, and it is possible to easily obtain electrode materials which do not excessively include carbon and are made of a fine and highly reactive electrode active material coated with a carbonaceous substance having higher electron conductivity. Electrode materials obtained in the above-described manner are capable of increasing electrode densities, increase discharge capacities at a high charge-discharge rate in a case in which batteries are formed, and enable charging and discharging at a high rate. In addition, the electrode material of the present invention has a large specific surface area and a small particle diameter, and thus favorable responsiveness is exhibited even in charge migration reactions on the electrode active material surface or reactions at a low temperature in which ion diffusivity degrades in particles.

The manufacturing method of the present invention is applicable regardless of the kind of the electrode active material and is particularly effective as a method for manufacturing olivine-type phosphate-based electrode materials having low electron conductivity due to the low costs and low environmental loads.

Electrode

An electrode of the present invention is formed using the electrode material of the present invention.

In order to produce the electrode of the present invention, the electrode material, a binder made of a binder resin, and a solvent are mixed together, thereby preparing paint for forming the electrode or paste for forming the electrode. At this time, a conductive auxiliary agent such as carbon black, acetylene black, graphite, ketjen black, natural graphite, or artificial graphite may be added thereto as necessary.

As the binder, that is, the binder resin, for example, a polytetrafluoroethylene (PTFE) resin, a polyvinylidene fluoride (PVdF) resin, fluorine rubber, or the like is preferably used.

The blending ratio between the electrode material and the binder resin is not particularly limited; however, for example, the content of the binder resin is set to 1 part by mass or more and 30 parts by mass or less and preferably set to 3 parts by mass or more and 20 parts by mass or less with respect to 100 parts by mass of the electrode material.

The solvent that is used for the paint for forming the electrode or the paste for forming the electrode may be appropriately selected in accordance with the properties of the binder resin.

Examples thereof include water, alcohols such as methanol, ethanol, 1-propanol, 2-propanol (isopropyl alcohol: IPA), butanol, pentanol, hexanol, octanol, and diacetone alcohol, esters such as ethyl acetate, butyl acetate, ethyl lactate, propylene glycol monomethyl ether acetate, propylene glycol monoethyl ether acetate, and γ-butyrolactone, ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether, ketones such as acetone, methyl ethyl ketone (MEK), methyl isobutyl ketone (MIBK), acetylacetone, and cyclohexanone, amides such as dimethyl formamide, N,N-dimethylacetoacetamide, and N-methylpyrrolidone, glycols such as ethylene glycol, diethylene glycol, and propylene glycol, and the like. These solvents may be used singly, or a mixture of two or more solvents maybe used.

Next, the paint for forming the electrode or the paste for forming the electrode is applied onto one surface of a metallic foil and then is dried, thereby obtaining a metallic foil having a coated film made of a mixture of the electrode material and the binder resin formed on one surface.

Next, the coated film is pressed under pressure and is dried, thereby producing a current collector (electrode) having an electrode material layer on one surface of the metallic foil.

In the above-described manner, direct current resistance is decreased, and it is possible to produce electrodes capable of increasing discharge capacities.

Lithium ion battery

A lithium ion battery of the present invention includes a cathode made of the electrode of the present invention.

When an electrode is produced using the electrode material of the present invention, this lithium ion battery is capable of decreasing the internal resistance of the electrode. Therefore, it is possible to suppress the internal resistance of the battery at a low level, and consequently, there is no concern of the significant drop of the voltage, and it is possible to provide lithium ion batteries capable of performing charging and discharging at a high rate.

In the lithium ion battery of the present invention, an anode, an electrolyte, a separator, and the like are not particularly limited. For example, as the anode, it is possible to use an anode material such as metallic Li, a carbon material, a Li alloy, or Li₄Ti₅O₁₂. In addition, instead of the electrolyte and the separator, a solid electrolyte may be used.

The lithium ion battery of the present invention includes the cathode made of the electrode of the present invention and thus has a high discharge capacity.

### Examples

Hereinafter, the present invention will be specifically described using examples and comparative examples. Meanwhile, the present invention is not limited to forms described in the examples.

For example, in the present examples, acetylene black is used as the conductive auxiliary agent, but a carbon material such as carbon black, graphite, Ketjen black, natural graphite, or artificial graphite may also be used. In addition, batteries in which Li₄Ti₅O₁₂ is used as the counter electrode will be evaluated, but it is needless to say that carbon materials such as natural graphite, artificial graphite, and coke and anode materials such as metallic Li or Li alloys may also be used. In addition, as a non-aqueous electrolytic solution (a solution of a non-aqueous electrolyte), an electrolyte which includes 1 mol/L of LiPF₆ and is produced by mixing ethylene carbonate and diethyl carbonate 1:1 in terms of % by volume, but an electrolyte in which LiBF₄ or LiClO₄ is used instead of LiPF₆ and propylene carbonate or diethyl carbonate is used instead of ethylene carbonate may be used. In addition, instead of the electrolyte and the separator, a solid electrolyte may be used.

Manufacturing Example 1: manufacturing of electrode active material (LiFePO₄)

LiFePO₄ was hydrothermally synthesized in the following manner.

LiOH as a Li source, NH₄H₂PO₄ as a P source, and FeSO₄·7H₂O as a Fe source (B source) were used and were mixed into pure water so that the substance amount ratio (Li/Fe/P) therebetween reached 3:1:1, thereby preparing a homogeneous slurry-form mixture (200 ml).

Next, this mixture was put into a pressure-resistant airtight container having a capacity of 500 mL and was hydrothermally synthesized at 170° C. for 12 hours. After this reaction, the mixture was cooled to room temperature (25° C.), thereby obtaining a cake-form reaction product which was precipitated in the container. This precipitate was sufficiently cleaned a plurality of times with distilled water, and the water content ratio was maintained at 30% so as to prevent the precipitate from being dried, thereby producing a cake-form substance. A slight amount of this cake-form substance was sampled, powder obtained by drying the cake-form substance in a vacuum at 70° C. for two hours was measured by means of X-ray diffraction, and it was confirmed that single-phase LiFePO₄ was formed.

Manufacturing Example 2: manufacturing of electrode active material (LiMnPO₄)

LiMnPO₄ was synthesized in the same manner as in Manufacturing Example 1 except for the fact that MnSO₄·H₂O was used instead of FeSO₄·7H₂O as the B source.

Manufacturing Example 3: manufacturing of electrode active material (Li [Fe_{0.25}Mn_{0.75}]PO₄)

Li [Fe_{0.25}Mn_{0.75}]PO₄ was synthesized in the same manner as in Manufacturing Example 1 except for the fact that a mixture of FeSO₄·7H₂O and MnSO₄·H₂O (at a substance amount ratio of 25:75) was used as the B source.

Example 1

LiFePO₄ (electrode active material) (20 g) obtained in Manufacturing Example 1, polyvinyl alcohol (PVA) (0.73 g) as a carbon source, and sodium polyacrylate (0.05 g) as a highly water-absorbing polymer were mixed into water so that the total amount reached 100 g and were crushed and mixed using a ball mill together with zirconia balls (150 g) having 5 mmφ, thereby obtaining a slurry (mixture).

Next, the obtained slurry was dried and granulated using a spray dryer. After that, the obtained granulated body was placed still in a high-humidity environment (30° C., a relative humidity of 100% RH) for one hour, the sodium polyacrylate (the highly water-absorbing polymer) was swollen and was then heated in a nitrogen (N₂) atmosphere at a temperature-increase rate of 20° C./minute, and a thermal treatment was carried out at a temperature of 770° C. for four hours, thereby obtaining an electrode material made of a carbonaceous-coated electrode active material.

Example 2

An electrode material made of a carbonaceous-coated electrode active material was obtained in the same manner as in Example 1 except for the fact that sodium polyalginate was used instead of sodium polyacrylate as a highly water-absorbing polymer.

Example 3

A granulated body was obtained in the same manner as in Example 1. The granulated body was uniformly spread in a 100 cm² rectangular container, and then water corresponding to 1% of the weight of the granulated body was sprayed onto the granulated body, thereby swelling the highly water-absorbing polymer. Next, the highly water-absorbing polymer was heated in a nitrogen (N₂) atmosphere at a temperature-increase rate of 20° C./minute, and a thermal treatment was carried out at a temperature of 770° C. for four hours, thereby obtaining an electrode material made of a carbonaceous-coated electrode active material.

Example 4

An electrode material made of a carbonaceous-coated electrode active material was obtained in the same manner as in Example 1 except for the fact that LiMnPO₄ (19 g) was used instead of LiFePO₄, a mixed solution of Li carbonate, iron (II) acetate, and phosphoric acid (Li/Fe/P=1:1:1) corresponding to 1 g of the weight of LiFePO₄ was used as a carbonization catalyst, polyvinyl alcohol (PVA) (1.1 g) was used as a carbon source, and sodium polyacrylate (0.05 g) was used as the highly water-absorbing polymer.

Example 5

An electrode material made of a carbonaceous-coated electrode active material was obtained in the same manner as in Example 1 except for the fact that Li [Fe_{0.25}Mn_{0.75}] PO₄ was used instead of LiFePO₄.

Example 6

An electrode material made of a carbonaceous-coated electrode active material was obtained in the same manner as in Example 1 except for the fact that sodium polyalginate was used instead of sodium polyacrylate as a highly water-absorbing polymer, and the amount of the sodium polyalginate added was set to 0.1 g which amounted to double the amount in Example 1.

Example 7

An electrode material made of a carbonaceous-coated electrode active material was obtained in the same manner as in Example 1 except for the fact that the thermal treatment was carried out at a temperature of 850° C. for three hours.

Comparative Example 1

An electrode material of Comparative Example 1 was obtained in the same manner as in Example 1 except for the fact that the highly water-absorbing polymer was not added.

Comparative Example 2

LiFePO₄ (electrode active material) (20 g) obtained in Manufacturing Example 1, polyvinyl alcohol (PVA) (0.73 g) as a carbon source, and sodium polyacrylate (0.05 g) as a highly water-absorbing polymer were mixed into water so that the total amount reached 100 g and were crushed and mixed using a ball mill together with zirconia balls (150 g) having 5 mmφ, thereby obtaining a slurry (mixture).

Next, the slurry was dried using a spray dryer so as to prevent the highly water-absorbing polymer in the obtained slurry from being swollen and are then, immediately, heated in a nitrogen (N₂) atmosphere at a temperature-increase rate of 20° C./minute, and a thermal treatment was carried out at a temperature of 770° C. for four hours, thereby obtaining an electrode material made of Comparative Example 2.

Comparative Example 3

An electrode material of Comparative Example 3 was obtained in the same manner as in Example 1 except for the fact that the temperature-increase rate during the thermal treatment was changed to 1.5° C./minute.

Comparative Example 4

An electrode material of Comparative Example 4 was obtained in the same manner as in Example 4 except for the fact that the highly water-absorbing polymer was not added.

Comparative Example 5

An electrode material of Comparative Example 5 was obtained in the same manner as in Example 5 except for the fact that the highly water-absorbing polymer was not added.

Comparative Example 6

An electrode material of Comparative Example 6 was obtained in the same manner as in Example 1 except for the fact that sucrose (2.5 g) was added thereto as the carbon source, the highly water-absorbing polymer was not added, and the thermal treatment was carried out at 600° C. for 0.5 hours.

Production of lithium ion batteries

The electrode material obtained in each of the examples and the comparative examples, acetylene black (AB) as a conductive auxiliary agent, and polyvinylidene fluoride (PVdF) as a binder were mixed into N-methyl-2-pyrrolidone (NMP) so that the weight ratio (the electrode material/AB/PVdF) therebetween reached 90:5:5, thereby producing cathode material paste. The obtained paste was applied and dried on a 30 μm-thick aluminum foil and was pressed so as to obtain a predetermined density, thereby producing an electrode plate.

A plate-like specimen including a 3×3 cm² coated surface and a space for a tab was obtained from the obtained the electrode plate by means of punching, and a tap was welded, thereby producing a test electrode.

Meanwhile, as a counter electrode, similarly, a coated electrode obtained by applying Li₄Ti₅O₁₂ was used. As a separator, a porous polypropylene film was employed. In addition, a lithium hexafluorophosphate (LiPF₆) solution (1 mol/L) was used as a non-aqueous electrolytic solution (a solution of a non-aqueous electrolyte). Meanwhile, as a solvent that was used in the LiPF₆ solution, a solvent obtained by mixing ethylene carbonate and diethyl carbonate 1:1 in terms of % by volume and adding vinylene carbonate (2%) thereto as an additive was used.

In addition, laminate-type cells were produced using the test electrode, the counter electrode, and the non-aqueous electrolytic solution produced in the above-described manner and were used as batteries of the examples and the comparative examples.

Evaluation of electrode materials

For the electrode materials obtained in the examples and the comparative examples and the components included in the electrode materials, properties were evaluated. The evaluation methods are as described below. Meanwhile, the results are shown in Table 1.

1. Crystallite diameter of electrode active material

The crystallite diameter of the electrode active material was calculated from the Debye-Scherrer equation using the full width at half maximum of the diffraction peak and the diffraction angle (20) of the (020) plane in a powder X-ray diffraction pattern measured by means of X-ray diffraction measurement (X-ray diffractormeter: RINT2000, manufactured by Rigaku Corporation).

2. Average particle diameter of carbonaceous-coated electrode active material

The average particle diameter of the carbonaceous-coated electrode active material was obtained by number-averaging the particle diameters of 200 or more particles which were measured by scanning electron microscope (SEM) observation.

3. Amount of carbon in electrode material The amount of carbon (% by mass) in the electrode material was measured using a carbon analyzer (manufactured by Horiba Ltd., carbon/sulfur combustion analyzer EMIA-810W).

4. Specific surface area of electrode material

The specific surface area of the electrode material was measured using a BET method by means of nitrogen (N₂) adsorption and a specific surface area meter (manufactured by MicrotracBEL Corp., trade name: BELSORP-mini).

5. Green compact resistance of electrode material The electrode material was injected into a mold and was molded at a pressure of 50 MPa, thereby producing a specimen. The powder resistivity (Ω·cm) of the specimen was measured using a low resistivity meter (manufactured by Mitsubishi Chemical Corporation, trade name: Loresta-GP) by means of four point measurement at 25° C.

Evaluation of electrodes and lithium ion batteries

Discharge capacities and direct current resistances (DCR) of charging and discharging were measured using the lithium ion batteries obtained in the examples and the comparative examples. The results are shown in Table 1.

1. Discharge capacity

Discharge capacities were measured at an ambient temperature of 0° C. by means of constant-current charging and discharging with the charge current set to 1 C, the discharge current set to 3 C, and the cut-off voltage set to 1 to 2V (vs Li₄Ti₅O₁₂) for the batteries of Examples 1, 2, 3, 6, and 7 and Comparative Examples 1, 2, 3, and 6 and to 1.2 to 3V (vs Li₄Ti₅O₁₂) for the batteries of Examples 4 and 5 and Comparative Examples 4 and 5.

2. Direct current resistance (DCR) of charging and discharging

The lithium ion batteries were charged with a current of 0.1 C at an ambient temperature of 0° C. for five hours, and the depths of charge were adjusted (state of charge (SOC) 50%). On the batteries adjusted to SOC 50%, “1 C charging for 10 seconds →10-minute rest→1 C discharging for 10 seconds→10-minute rest” as a first cycle, “3 C charging for 10 seconds→10-minute rest→3 C discharging for 10 seconds→10-minute rest” as a second cycle, “5 C charging for 10 seconds→10-minute rest→5 C discharging for 10 seconds→10-minute rest” as a third cycle, and “10 C charging for 10 seconds→10-minute rest→10 C discharging for 10 seconds→10-minute rest” as a fourth cycle were sequentially carried out. Voltages 10 seconds after the respective charging and discharging during the cycles were measured. Individual current values were plotted along the horizontal axis, and the voltages after 10 seconds were plotted along the vertical axis, thereby drawing approximate straight lines. The slopes of the approximate straight lines were respectively considered as direct current resistances during charging (charging DCR) and direct current resistances during discharging (discharging DCR).

TABLE 1

| | | Crystallite | | Amount of | | Green | | | |
|---|---|---|---|---|---|---|---|---|---|
| | | diameter of | Average particle | carbon in | Specific | compact | | | |
| | | electrode | diameter of | electrode | surface area | resistance | 3 C | | |
| | | active | carbonaceous-coated | material | of electrode | of electrode | discharge | Charging | Discharging |
| | Electrode active | material | electrode active | (% by | material | material | capacity | DCR | DCR |
| | material | (nm) | material (nm) | mass) | (m²/g) | (Ω · cm) | (mAh/g) | (Ω) | (Ω) |
| Example 1 | LiFePO₄ | 58 | 66 | 1.0 | 12.1 | 1.3 × 10² | 124 | 2.2 | 2.1 |
| Example 2 | LiFePO₄ | 66 | 74 | 1.1 | 12.5 | 1.1 × 10² | 120 | 2.5 | 2.3 |
| Example 3 | LiFePO₄ | 60 | 71 | 1.0 | 12.1 | 1.2 × 10² | 122 | 2.3 | 2.2 |
| Example 4 | LiMnPO₄ | 52 | 92 | 1.5 | 16.3 | 7.7 × 10² | 105 | 2.9 | 2.6 |
| Example 5 | Li[Fe_{0.25}Mn_{0.75}]PO₄ | 54 | 101 | 1.0 | 14.0 | 1.6 × 10² | 112 | 2.5 | 2.4 |
| Example 6 | LiFePO₄ | 33 | 40 | 1.0 | 13.3 | 1.6 × 10² | 127 | 2.1 | 2.0 |
| Example 7 | LiFePO₄ | 103 | 180 | 0.9 | 9.0 | 1.1 × 10¹ | 109 | 2.5 | 2.2 |
| Comparative | LiFePO₄ | 124 | 206 | 0.9 | 9.0 | 1.4 × 10² | 100 | 3.0 | 2.7 |
| Example 1 | | | | | | | | | |
| Comparative | LiFePO₄ | 122 | 200 | 1.0 | 9.1 | 1.1 × 10² | 101 | 2.9 | 2.6 |
| Example 2 | | | | | | | | | |
| Comparative | LiFePO₄ | 135 | 226 | 0.9 | 9.0 | 9.9 × 10¹ | 96 | 3.0 | 2.8 |
| Example 3 | | | | | | | | | |
| Comparative | LiMnPO₄ | 112 | 200 | 1.4 | 11.0 | 8.2 × 10² | 88 | 4.0 | 3.6 |
| Example 4 | | | | | | | | | |
| Comparative | Li[Fe_{0.25}Mn_{0.75}]PO₄ | 119 | 197 | 1.0 | 10.0 | 1.6 × 10² | 92 | 3.2 | 2.9 |
| Example 5 | | | | | | | | | |
| Comparative | LiFePO₄ | 120 | 212 | 2.2 | 10.3 | 7.9 × 10⁴ | 90 | 3.8 | 3.1 |
| Example 6 | | | | | | | | | |

Summary of results

In the electrode materials of Examples 1 to 7, it could be confirmed that substance migration between the particles was suppressed due to the extension of the particle gaps in the electrode active materials which was caused by the swelling of the highly water-absorbing polymers, and particle growth and sintering was suppressed even during the thermal treatments at a high temperature, and thus, in spite of the addition of a small amount of the carbon source (the amounts of carbon), the electron conductivity of the carbonaceous films sufficiently improved, the discharge capacities increased, and the direct current resistances decreased.

On the other hand, in the electrode materials of Comparative Examples 1, 4, and 5, the highly water-absorbing polymer was not added thereto, and thus it was found that the particle gaps in the electrode active materials did not extend, the growth of the particles occurred in response to the thermal treatments, consequently, the discharge capacity decreased, and the direct current resistances increased. In the electrode material of Comparative Example 2, the highly water-absorbing polymer did not swell, and thus it was found that the particle gaps in the electrode active materials did not extend, the growth of the particles occurred in response to the thermal treatments, consequently, the discharge capacities decreased, and the direct current resistances increased. In the electrode material of Comparative Example 3, the temperature-increase rate during the thermal treatment was slow, the swollen highly water-absorbing polymer was dried and shrunk again, the particle gaps in the electrode active material narrowed again, and then the organic substance was carbonized at a high temperature, and thus it was found that the growth of the particles occurred, consequently, the discharge capacity decreased, and the direct current resistance increased. In addition, in the electrode material of Comparative Example 6, although the highly water-absorbing polymer was not added thereto, the thermal treatment temperature was low, and the time was short, and thus the particles did not grow violently. However, accordingly, the organic substance was insufficiently carbonized, the green compact resistance was great, and the direct current resistance also became great.

The electrode material of the present invention is useful as cathodes for lithium ion batteries.

What is claimed is:

1. An electrode material made of a carbonaceous-coated electrode active material having
primary particles of an electrode active material and aggregates of the primary particles, and
a carbonaceous film that coats the primary particles of the electrode active material and the aggregates of the primary particles,
wherein an average particle diameter of the carbonaceous-coated electrode active material is 30 nm or more and 200 nm or less, a crystallite diameter obtained from a full width at half maximum of a (020) plane in an X-ray diffraction measurement is 30 nm or more and 100 nm or less, a specific surface area obtained using a BET method is 10 m²/g or more and 25 m²/g or less, and a carbon content is 0.5% by mass or more and 2.5% by mass or less.

2. The electrode material according to claim 1, wherein the electrode active material is an electrode active material substance represented by General Formula (1),
LiₐAₓBO₄ (1)
(here, in the formula, A represents at least one element selected from the group consisting of Mn, Fe, Co, and Ni, B represents at least one element selected from the group consisting of P, Si, and S, 0≦a<4, and 0<x<1.5).

3. A method for manufacturing the electrode material according to claim 1, comprising:
a first step of obtaining a mixture including an organic substance (A) which serves as a carbon source, a highly water-absorbing polymer (B), and an electrode active material and/or an electrode active material precursor (C);
a second step of obtaining a solid substance by humidifying the mixture obtained in the first step; and
a third step of thermally treating the solid substance obtained in the second step in a non-oxidative atmosphere at 600° C. or higher and 1,000° C. or lower.

4. The method for manufacturing the electrode material according to claim 3,
wherein the highly water-absorbing polymer (B) is a polymer absorbing water that weighs ten or more times a weight of the polymer.

5. An electrode formed using the electrode material according to claim 1.

6. A lithium ion battery comprising:
a cathode made of the electrode according to claim 5.
